(19) United States
(12) Patent Application Publication
(10) Pub. No.: US 2018/0334521 A1
(43) Pub. Date: Nov. 22, 2018

(54) VULCANIZABLE COMPOSITION AND MOLDABLE THERMOPLASTIC ELASTOMER PRODUCT THEREFROM

(71) Applicant: KURARAY CO., LTD., Okayama (JP)

(72) Inventors: Marcel GRUENDKEN, Hattersheim am Main (DE); Ralph BOEHM, Hattersheim am Main (DE); Heith FOSTER, Friendswood, TX (US); Yoshihiro MORISHITA, Ibaraki (JP)

(73) Assignee: KURARAY CO., LTD., Okayama (JP)

(21) Appl. No.: 15/970,096

(22) Filed: May 3, 2018

Related U.S. Application Data
(60) Provisional application No. 62/507,324, filed on May 17, 2017.

(51) Int. Cl. C08F 236/10; C08F 212/12; C08F 10/02; C08F 10/06

(52) U.S. Cl. CPC C08F 236/10; C08F 212/12; C08F 10/02; C08F 2500/03; C08F 2500/02; C08F 2800/20; C08F 2810/20; C08F 10/06

(57) ABSTRACT

The present invention relates to a vulcanizable composition comprising a specific block copolymer thermoplastic elastomer, a polyolefin, a rubber softener, a crosslinking agent and a specified liquid diene rubber crosslinking co-agent, and a dynamically vulcanized composition produced by intimately mixing the above components under shear and at elevated temperature, which dynamically vulcanized composition is thermoplastic, elastic and moldable.

### CROSS-REFERENCE TO RELATED APPLICATIONS

This application claims priority under 35 U.S.C. § 119 from U.S. Provisional Application Ser. No. 62/507,324 (filed 17 May 2017), the disclosure of which is incorporated by reference herein for all purposes as if fully set forth.

### FIELD OF THE INVENTION

The present invention relates to a vulcanizable composition comprising a mixture of specific block copolymer thermoplastic elastomer, a polyolefin, a rubber softener, a crosslinking agent and a liquid diene rubber crosslinking co-agent. A moldable thermoplastic elastomer composition is produced by intimately mixing the above components under dynamic vulcanization conditions of shear and elevated temperature. The resulting dynamically vulcanized thermoplastic elastomer composition is flexible, has excellent elastomeric properties and is moldable. It is very effectively useable in automobile parts, civil engineering and construction applications, home-appliance parts, sporting goods, sundry goods, stationery and other various molded articles, and other wide-ranging applications.

### BACKGROUND OF THE INVENTION

Thermoplastic elastomers (“TPEs”) are soft materials having rubber elasticity, and can be molded and recycled as thermoplastic resins. TPEs have been frequently used in the fields of, for example, automobile parts, home-appliance parts, wire coating, medical parts, sundry goods and footgear.

TPEs based on an addition block copolymer having a polymer block comprising an aromatic vinyl compound (hard segment) and a polymer block comprising a conjugated diene compound (soil segment), are in a general sense well known to those of ordinary skill in the relevant art and are generally commercially available. These TPEs can be crosslinked, for example, to improve rubber elasticity (compression set) at high temperatures.

Vulcanizable compositions comprising such block copolymer TPEs, polyolefins, rubber softeners, crosslinking agents, crosslinking co-agents and a variety of other optional components are also generally well known, as exemplified by U.S. Pat. No. 7,074,855B2. Depending on the components and conditions, the vulcanizable compositions can be dynamically vulcanized to create crosslinks in one or both of the hard and soft segments of the addition block copolymer, and result in TPE compositions that are moldable and have use in producing a variety of molded articles.

Known crosslinking co-agents include, for example, peroxides, disulfide compounds such as benzothiazyl disulfide and tetramethylthiuram disulfide, triallyl isocyanurate, divinylbenzene, ethylene glycol dimethacrylate, triethylene glycol dimethacrylate, and other polyfunctional monomers.

The most commonly-used crosslinkers are peroxides, and particularly organic peroxides. When peroxides are used as crosslinking agents, the most common crosslinking co-agent is triallyl isocyanurate (“TAIC”). When dynamically vulcanized, TAIC reacts, has crosslinking ability and at least a portion becomes chemically bonded to the addition block copolymer.

While generally effective, TAIC is a lower molecular weight component and can migrate readily easily, resulting in potentially poor mixing and a higher VOC (volatile organic content) level. TAIC also has a noticeable odor.

In addition to the migration and VOC issues with TAIC, it is also desirable to improve properties of the resulting crosslinked (vulcanized) TPE compositions, and particularly properties relating to molding and molded article end uses, such as compression set, tensile strength and elongation.

JP2003-213051A does disclose the use of a hydroxyl-group terminated modified liquid polybutadiene in a vulcanizable compound including a thermoplastic elastomer, olefinic copolymer rubber and an organic peroxide, but does not disclose or remotely suggest the desirability of replacing TAIC with a liquid diene rubber (and even more so an unmodified liquid diene rubber) as a co-crosslinking agent in such system. In fact, the reference discloses using co-crosslinkers such as TAIC as optional components in the disclosed systems.

The present invention addresses these specific aspects and others.

### SUMMARY OF THE INVENTION

In accordance with a first aspect of the present invention, there is provided a vulcanizable composition comprising a mixture of:

(a) 100 parts by weight of an addition block copolymer thermoplastic elastomer having at least one polymer block (A) comprising units derived from an aromatic vinyl compound, and at least one polymer block (B) comprising units derived from a conjugated diene compound;

(b) a polyolefin component in an amount of from about 10 to about 300 parts by weight;

(c) a rubber softener component in an amount of from about 10 to about 300 parts by weight;

(d) a peroxide crosslinking agent in an amount of from about 0.01 to about 10 parts by weight; and

(e) a crosslinking co-agent,

wherein:

the crosslinking co-agent comprises a liquid diene rubber in an amount of from about 1 to about 50 parts by weight, and

the weight ratio of the peroxide crosslinking agent to the liquid diene rubber is from about 0.01 to about 1.

Desirably, the vulcanizable composition is a substantially uniform mixture of the components.

In a second aspect, the present invention provides a moldable composition comprising a dynamically vulcanized (under shear and elevated temperature) product of the above vulcanizable composition, wherein the addition block copolymer is crosslinked in both the blocks (A) and (B), and wherein at least a portion of the liquid diene rubber is chemically bonded to the addition block copolymer.

In one embodiment, such composition has a morphological structure in which the polyolefin component forms a continuous phase.

In a third aspect, the present invention provides a moldable composition comprising a mixture of:

(a) 100 parts by weight of an addition block copolymer thermoplastic elastomer having at least one polymer block (A) comprising units derived from an aromatic vinyl compound, and at least one polymer block (B) comprising units derived from a conjugated diene compound, wherein the block copolymer is crosslinked in both the blocks (A) and (B);

(b) a polyolefin component in an amount of from about 10 to about 300 parts by weight;

(c) a rubber softener component in an amount of from about 10 to about 300 parts by weight; and

(e) a liquid diene rubber in an amount of from about 1 to about 50 parts by weight, wherein at least a portion of the liquid diene rubber is chemically bonded to the addition block copolymer.

In one embodiment, such composition has a morphological structure in which the polyolefin component forms a continuous phase. In another embodiment, the mixture is a substantially uniform mixture.

In a fourth aspect, the present invention provides a process for preparing a moldable thermoplastic elastomer composition, comprising the steps of:

(1) mixing (a) an addition block copolymer thermoplastic elastomer having at least one polymer block (A) comprising units derived from an aromatic vinyl compound, and at least one polymer block (B) comprising units derived from a conjugated diene compound, (b) a polyolefin, (c) a rubber softener, (d) a peroxide crosslinking agent, and (e) a crosslinking co-agent, to form a pre-blend, and

(2) dynamically vulcanizing the pre-blend under shear and elevated temperature conditions to form crosslinks in both the blocks (A) and (B),

wherein the crosslinking co-agent comprises a liquid diene rubber,

in the dynamically vulcanizing step at least a portion of the liquid diene rubber chemically bonds to the addition block copolymer, and

the ratio of components is 100 parts by weight of (a), about 10 to about 300 parts by weight of (b), about 10 to about 300 parts by weight of (c), about 0.01 to about 10 parts by weight of (d), and about 1 to about 50 parts by weight of (e), and the weight ratio of the peroxide crosslinking agent to the liquid diene rubber is from about 0.01 to about 1.

In one embodiment, the mixing step produces a substantially uniform mixture of the components. In another embodiment, the mixing step is done under conditions such that substantially no dynamic vulcanization occurs. In another embodiment, the moldable thermoplastic elastomer composition is a substantially uniform mixture of the crosslinked addition block copolymer, polyolefin, rubber softener and liquid diene rubber, wherein at least a portion of the liquid diene rubber is chemically bonded to the addition block copolymer.

In a fifth aspect, the present invention provides an article molded from the moldable crosslinked thermoplastic elastomer composition.

Desirably, in block (A) (the “hard segment”), the addition block copolymer (a) has units derived from an alkylstyrene compound containing from 1 to 8 carbon atoms in its alkyl group. In one embodiment, the alkylstyrene is a p-alkylstyrene, or more specifically p-methylstyrene.

Desirably, in block (B) (the “soft segment”), the addition block copolymer (a) has units derived from a conjugated diene. Desirably, the conjugated diene includes at least butadiene, isoprene or a mixture thereof. In one embodiment, the addition block copolymer is at least partially hydrogenated.

Desirably, the liquid diene rubber is a polymer that contains isoprene and/or butadiene units in an amount of not less than 50 mass % relative to all the monomer units constituting the polymer, and is also desirably an unmodified liquid diene rubber.

These and other embodiments, features and advantages of the present invention will be more readily understood by those of ordinary skill in the art from a reading of the following detailed description.

### DETAILED DESCRIPTION

The present invention will now be illustrated in further detail.

In the context of the present description, all publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight.

For clarity, “parts by weight” is based on 100 parts by weight of component (a) (the addition block copolymer thermoplastic elastomer). For example, 1 part by weight of component (d) (the liquid diene rubber co-agent) would mean that 1 part by weight of component (d) would be present for every 100 parts by weight of component (a).

Unless stated otherwise, pressures expressed in psi units are gauge, and pressures expressed in kPa units are absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used in describing a value or an endpoint of a range, the disclosure should be understood to include the specific value or endpoint referred to. In other words, “about 25 to about 50” explicitly discloses the endpoint values of “25” and “50”, and the range of “25 to 50”.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

The term “predominant portion”, as used herein, unless otherwise defined herein, means that greater than 50% of the referenced material. If not specified, the percent is on a molar basis when reference is made to a molecule (such as hydrogen, methane, carbon dioxide, carbon monoxide and hydrogen sulfide), and otherwise is on a weight basis (such as for carbon content).

The term “depleted” or “reduced” is synonymous with reduced from originally present. For example, removing a substantial portion of a material from a stream would produce a material-depleted stream that is substantially depleted of that material. Conversely, the term “enriched” or “increased” is synonymous with greater than originally present.

The term “number-average molecular weight” or “Mn” means a number-average molecular weight, and the term “weight-average molecular weight” or “Mw” means a weight-average molecular weight, as determined by gel permeation chromatography (GPC) based on a standard polystyrene calibration curve. The measuring apparatuses and conditions are as follows. Apparatus: GPC device HLC-8320GPC EcoSEC (Tosoh Corporation); separating column: TSKgel SuperHZ4000 (Tosoh Corporation); eluent: tetrahydrofuran; eluent flow rate: 0.35 mL/min; sample concentration: 5 mg/10 mL; and column temperature: 40° C.

The term “thermoplastic” has its normal meaning, namely, a substance that can become plastic on heating and hardens on cooling through multiple cycles, as would be understood by a person of ordinary skill in the relevant art.

The term “elastomer” also has its normal meaning, namely, a substance that has elastic properties, as would be understood by a person of ordinary skill in the relevant art.

The term “substantially uniform mixture” means that the components of the mixture are substantially evenly distributed throughout the mixture on a mass basis. The mixture may have discontinuous domains (of the same or different sizes) of one component in a continuous domain of another component, in which case the discontinuous domains would be substantially evenly distributed within the continuous domain (on a mass basis). The intent is that the level of uniformity is that achievable by common industrial mixing equipment operated under commercially applicable conditions, as would be recognized by a person of ordinary skill in the relevant art.

For convenience, many elements of the present invention are discussed separately, lists of options may be provided and numerical values may be in ranges; however, for the purposes of the present disclosure, that should not be considered as a limitation on the scope of the disclosure or support of the present disclosure for any claim of any combination of any such separate components, list items or ranges. Unless stated otherwise, each and every combination possible with the present disclosure should be considered as explicitly disclosed for all purposes.

Although methods and materials similar or equivalent to those described herein can be used in the practice or testing of the present disclosure, suitable methods and materials are described herein. The materials, methods, and examples herein are thus illustrative only and, except as specifically stated, are not intended to be limiting.

### Addition Block Copolymer Thermoplastic Elastomer (a)

The addition block copolymer thermoplastic elastomer (a) serving as a base component of the compositions of the present invention is a block copolymer having at least one polymer hard segment block (A) comprising aromatic vinyl compound units, and at least one polymer soft segment block (B) comprising conjugated diene compound units.

As discussed below, after vulcanization the addition block copolymer (a) is crosslinked in both the polymer block (A) and the polymer block (B).

As indicated previously, the polymer block (A) comprises units derived from an aromatic vinyl compound and constitutes a “hard segment”, and the polymer block (B) comprises units derived from a conjugated diene compound and constitutes a “soft segment”.

The addition block copolymer can, for example, be a diblock copolymer, a triblock copolymer, a tetrablock copolymer or higher multiblock copolymer. Blocks other than the (A) and (B) blocks, and (A) and (B) blocks of different compositions, may be present as well.

Exemplary block arrangements are as follows: A-B, A-B-A, B-A-B, A1-B-A2, B1-A-B2, A-B-A-B-A, A1-B-A2-B-A1, B1-A-B2-A-B1, etc.

In one embodiment, the addition block copolymer is a triblock of an A-B-A or an A1-B-A2 structure.

Typically, the addition block copolymer is at least partially hydrogenated to remove some or substantially all of residual unsaturation.

Such addition block copolymer thermoplastic elastomers are in a general sense well known to those of ordinary skill in the relevant art, as exemplified by previously incorporated U.S. Pat. No. 7,074,855B2, as well as U.S. Pat. No. 4,987,194 and U.S. Pat. No. 4,985,499. Versions suitable for use in connection with the present invention are generally commercially available, for example, the SEPTON™ 2000 series (SEPTON™ 2002, SEPTON™ 2004, SEPTON™ 2005, SEPTON™ 2006, SEPTON™ 2063, SEPTON™ 2104, etc.), the SEPTON™ 4000 series (SEPTON™ 4033, SEPTON™ 4044, SEPTON™ 4055, SEPTON™ 4077, SEPTON™ 4099, etc.), the SEPTON™ 8000 series (SEPTON™ 8004, SEPTON™ 8006, SEPTON™ 8007, SEPTON™ 8076, etc.), the SEPTON™ V series (SEPTON™ V9461, SEPTON™ V9475, SEPTON™ V9827, etc.), the HYBRAR™ 5000 series (HYBRAR™ 5125, HYBRAR™ 5127, etc.), the HYBRAR™ 7000 series (HYBRAR™ 7125, HYBRAR™ 7311, etc.) (Kuraray Co., Ltd., Tokyo, JP); the Kraton™ D series (D1102, D1161, etc.), Kraton™ G series (G1654, G1652, G1651, G1650, G1645, G1633, etc.) (Kraton Corporation); and the TAIPOL™ SEBS series (TAIPOL™ 6150, TAIPOL™ 6151, TAIPOL™ 6152, TAIPOL™ 6153, TAIPOL™ 6154, TAIPOL™ 6159, etc.) (TSRC) can be used.

Additional exemplary details are as follows.

In one embodiment, the aromatic vinyl compound is an alkylstyrene containing 1 to 8 carbon atoms in its alkyl group(s), and the block (A) thus has units derived from an alkylstyrene compound containing 1 to 8 carbon atoms in its alkyl groups. Typically, the alkylstyrene compound has at least one of the alkyl groups being combined with its benzene ring. General examples of such compounds include o-alkylstyrenes, m-alkylstyrenes, p-alkylstyrenes, 2,4-dialkylstyrenes, 3,5-dialkylstyrenes and 2,4,6-trialkylstyrenes, each containing 1 to 8 carbon atoms in the alkyl group, as well as halogenated alkylstyrenes corresponding to the aforementioned alkylstyrenes except with halogen atoms replacing one or more of hydrogen atoms in the alkyl group. Specific examples of such alkylstyrenes compounds include o-methylstyrene, m-methylstyrene, p-methylstyrene, 2,4-dimethylstyrene, 3,5-dimethylstyrene, 2,4,6-trimethylstyrene, o-ethylstyrene, m-ethylstyrene, p-ethylstyrene, 2,4-diethylstyrene, 3,5-diethylstyrene, 2,4,6-triethylstyrene, o-propylstyrene, m-propylstyrene, p-propylstyrene, 2,4-dipropylstyrene, 3,5-dipropylstyrene, 2,4,6-tripropylstyrene, 2-methyl-4-ethylstyrene, 3-methyl-5-ethylstyrene, o-chloromethylstyrene, m-chloromethylstyrene, p-chloromethylstyrene, 2,4-bis(chloromethyl)styrene, 3,5-bis(chloromethyl)styrene, 2,4,6-tri(chloromethyl)styrene, o-dichloromethylstyrene, m-dichloromethylstyrene, and p-dichloromethylstyrene.

In one embodiment, the alkylstyrene is a p-alkylstyrene, and more specifically p-methylstyrene.

The content of the alkylstyrene-derived structural unit in the polymer block (A) may be about 1% by weight or more, or about 5% by weight or more, or about 10% by weight or more based on the weight of the polymer block (A). Further, the content of the alkylstyrene-derived structural unit in the polymer block (A) may be about 90% by weight or less, or about 70% by weight or less, or about 50% by weight or less based on the weight of the polymer block (A). When the addition block copolymer has two or more polymer blocks (A), the term “weight of the polymer block (A)” means the total weight of the two or more polymer blocks (A).

In one embodiment, all the units constituting the polymer block (A) may comprise the alkylstyrene-derived structural units.

The polymer block (A) may comprise aromatic vinyl compound derived units other than the (C₁-C₈ alkyl)styrene-derived units. Such other aromatic vinyl compound units include, for example, units derived from styrene, α-methylstyrene, β-methylstyrene, t-butylstyrene, monofluorostyrene, difluorostyrene, monochlorostyrene, dichlorostyrene, methoxystyrene, vinylnaphthalene, vinylanthracene, indene, and acetonaphthylene. When present, styrene units are preferred as the other aromatic vinyl compound units.

When the polymer block (A) has the other aromatic vinyl compound units in addition to the (C₁-C₈ alkyl)styrene-derived structural unit, the (C₁-C₈ alkyl)styrene-derived structural unit and the other aromatic vinyl compound units can be combined in any form such as random form, block form, and tapered block form.

The polymer block (A) may further comprise small amounts of structural units derived from other copolymerizable monomers in addition to the structural unit(s) derived from aromatic vinyl compound(s). In this case, the proportion of the structural units derived from the other copolymerizable monomers is typically about 30% by weight or less, or about 10% by weight or less, based on the total weight of the polymer block (A). Suitable other copolymerizable monomers include, for example, methacrylic esters, acrylic esters, 1-butene, pentenes, hexenes, butadienes, isoprene, methyl vinyl ether, and other monomers that can undergo ion polymerization. These other copolymerizable monomers may constitute any form such as random form, block form, and tapered block form.

The polymer block (A) may further include one or more functional groups that can be crosslinked. In another embodiment, the polymer block (A) may not include such functional groups. When the polymer block (A) includes the functional groups, mechanical properties can be modified improved. When the polymer block (A) does not include any of the functional groups, moldability properties tend to be optimized. Examples include functional groups having active hydrogen atoms, such as functional groups represented by following formulae: —OH, —SH, —NH₂, —NHR, —CONH₂, —CONHR, —CONH—, —SO₃H, —SO₂H, and —SOH, wherein R is a hydrocarbon group; functional groups having nitrogen atoms, such as functional groups represented by following formulae: —NR₂, >C═NH, >C═N—, —CN, —NCO, —OCN, —SCN, —NO, —NO₂, —NCS, —CONR₂, and —CONR—, wherein R is a hydrocarbon group; functional groups each having a carbonyl group or thiocarbonyl group, such as functional groups represented by following formulae: >C═O, >C═S, —CH═O, —CH═S, —COOR, and —CSOR, wherein R is a hydrocarbon group; epoxy group, and thioepoxy group.

If present, the functional group is typically a hydroxyl group.

When the addition block copolymer (a) has the functional group in the polymer block (A) and is crosslinked therethrough, the content of the functional group in the polymer block (A) can vary depending on, for example, the number of bonded blocks and the molecular weight of the addition block copolymer (a).

When the polymer block (A) has both the (C₁-C₈ alkyl)styrene-derived structural unit and the functional group (in the same or different polymer blocks (A)), it is preferred that the content of the (C₁-C₈ alkyl)styrene-derived structural unit is from 1 to 90% by weight based on the weight of the polymer block(s) (A), and the content of the functional group is from 1 to 1,000 groups per molecule of the addition block copolymer (a).

Examples of conjugated diene compounds constituting the polymer block (B) in the addition block copolymer (a) include isoprene, butadienes, hexadienes, 2,3-dimethyl-1,3-butadiene and 1,3-pentadiene. The polymer block (B) may comprise only one of these conjugated diene compounds or may comprise two or more of these conjugated diene compounds. When the polymer block (B) has structural units derived from two or more of conjugated diene compounds, these structural units may be combined in any form such as random, tapered, block, and any combination of these forms.

For satisfactory weather resistance, heat resistance, and other properties, the polymer block (B) is typically a polyisoprene block comprising monomer units mainly containing isoprene units, or a corresponding hydrogenated polyisoprene block in which part or all of the unsaturated bonds of the polyisoprene block are hydrogenated; a polybutadiene block comprising monomer units mainly containing butadiene units, or a corresponding hydrogenated polybutadiene block in which part or all of the unsaturated bonds of the polybutadiene block are hydrogenated; or an isoprene/butadiene copolymer block comprising monomer units mainly containing isoprene units and butadiene units, or a corresponding hydrogenated isoprene/butadiene copolymer block in which part or all of the unsaturated bonds thereof are hydrogenated. The polymer block (B) is more preferably a hydrogenated block of the polyisoprene block, the polybutadiene block, or the isoprene/butadiene copolymer block.

In a polyisoprene block, the units derived from isoprene include, before hydrogenation, at least one group selected from the group consisting of a 2-methyl-2-butene-1,4-diyl group [—CH₂—C(CH₃)═CH—CH₂—; 1,4-bonded isoprene unit], an isopropenylethylene group [—CH(C(CH₃)═CH₂)—CH₂—; 3,4-bonded isoprene unit], and a 1-methyl-1-vinylethylene group [—C(CH₃) (CH═CH₂)—CH₂—; 1,2-bonded isoprene unit]. The proportions of individual units are not specifically limited. In a polyisoprene block, it is preferred that, before hydrogenation, the isoprene units include from about 99 mol %, or from about 97 mol %, to about 10 mol %, or to about 30 mol %, of 2-methyl-2-butene-1,4-diyl groups [—CH₂—C(CH₃)═CH—CH₂—; 1,4-bonded. isoprene unit]; and from about 1 mol %, or from about 3 mol %, to about 90 mol %, or to about 70 mol %, of the total amount of isopropenylethylene groups [—CH(C(CH₃)═CH₂)—CH₂—; 3,4-bonded isoprene unit] and 1-methyl-1-vinylethylene groups [—C(CH₃) (CH═CH₂)—CH₂—; 1,2-bonded isoprene unit]. When the amount of the 1,4-bonds in the polyisoprene block is within the above-specified ranges, the rubber properties become further satisfactory.

In a polybutadiene block, it is preferred that, before hydrogenation, the butadiene units include from about 70 mol %, or from about 65 mol %, to about 10 mol %, or to about 30 mol %, of 2-butene-1,4-diyl groups [—CH₂—CH═CH—CH₂—; 1,4-bonded butadiene unit]; and from about 30 mol %, or from about 35 mol %, to about 90 mol %, or to about 70 mol %, of vinylethylene groups [—CH(CH═CH₂)—CH₂—; 1,2-bonded butadiene unit]. When the amount of the 1,4-bonds in the polybutadiene block is within the above-specified ranges, the rubber properties become further satisfactory.

In an isoprene/butadiene copolymer block, the units derived from isoprene include, before hydrogenation, at least one group selected from the group consisting of a 2-methyl-2-butene-1,4-diyl group, an isopropenylethylene group, and a 1-methyl-1-vinylethylene group, and the units derived from butadiene include a 2-butene-1,4-diyl group and/or a vinylethylene group. The proportions of individual units are not specifically limited. In an isoprene/butadiene copolymer block, it is preferred that, before hydrogenation, the units derived from isoprene and butadiene include from about 99 mol %, or from about 97 mol %, to about 5 mol %, or to about 20 mol %, of the sum of 2-methyl-2-butene-1,4-diyl groups and 2-butene-1,4-diyl groups; and from about 1 mol %, or from about 3 mol %, to about 95 mol %, or to about 80 mol %, of the sum of isopropenylethylene groups, 1-methyl-1-vinylethylene groups and vinylethylene groups. When the total amount of the 1,4-bonded isoprene unit and 1,4-bonded butadiene unit in the isoprene/butadiene copolymer block is within the above-specified ranges, the rubber properties become further satisfactory. The arrangement or configuration of the isoprene units and the butadiene units in the isoprene/butadiene copolymer block can be any form such as random form, block form, and tapered block form. To further effectively improve the rubber properties, the molar ratio of the isoprene units and the butadiene units (isoprene units:butadiene units) is preferably in a range from about 1:9, or about 3:7, to about 9:1, or to about 7:3.

The polymer block (B) may further comprise minor amounts of structural units derived from other copolymerizable monomers in addition to the structural units derived from conjugated dienes. In this case, the proportion of the other copolymerizable monomers is usually about 30% by weight or less, or about 10% by weight or less, based on the total weight of the polymer block (B). Other suitable copolymerizable monomers include, for example, styrene, p-methylstyrene, α-methylstyrene, and other monomers that can undergo ion polymerization.

For further satisfactory heat resistance and weather resistance of the thermoplastic elastomer composition comprising the addition block copolymer (a), part or all of unsaturated double bonds in the polymer block (B) are typically hydrogenated. The hydrogenation ratio in polymer block (B) based on the number of mole of unsaturated double bonds in the polymer block (B) before hydrogenation is usually about 60 mol % or more, or about 80 mol % or more, or substantially complete hydrogenation (substantially 100 mol % hydrogenation). As the hydrogenation ratio in polymer block (B) increases, the reactivity between the polymer block (B) and the crosslinking agent (d) decreases, and crosslinks can be more selectively introduced into the polymer block (A) constituting the hard segment.

The overall degree of crosslinking in the addition block copolymer (a) can be controlled according to the polymer composition and end use. For good strain recovery (rubber elasticity) at high temperatures, the degree of crosslinking is desirably such that, when an addition block copolymer after crosslinking is subjected to Soxhlet extraction with cyclohexane for 10 hours, the weight percentage of gel (gel fraction) which is not dissolved in cyclohexane and remains to the weight of the crosslinked addition block copolymer (a) before extraction is about 80% or more.

The molecular weight of the addition block copolymer (a) is not specifically limited. From the viewpoints of the mechanical properties and moldability of the resulting vulcanized thermoplastic elastomer composition, it is preferred that, before hydrogenation and dynamic vulcanization (i.e., in the addition block copolymer (a) before any hydrogenation or crosslinking), the number-average molecular weight of the polymer block (A) is from about 2,500, or from about 5,000, to about 75,000, or to about 50,000; the number-average molecular weight of the polymer block (B) is from about 10,000, or from about 30,000, to about 300,000, or to about 250,000; and the total number-average molecular weight of the entire addition block copolymer (a) is from about 12,500, or from about 50,000, to about 2,000,000, or to about 1,000,000.

The method for producing the addition block copolymer is not especially limited. The addition block copolymer can, for example, be produced by the methods well known to those of ordinary skill in the art, as disclosed in the US 2009/0264590A1, US2010/0190912A1, US2015/0299370A1, etc.

### Polyolefin Component (b)

The polyolefin component (b) for use in the thermoplastic elastomer composition of the present invention includes, for example, ethylene polymers, propylene polymers, polybutene-1, and poly(4-methylpentene-1). Each of these polyolefins can be used alone or in combination. Among them, ethylene polymers and/or propylene polymers are preferred as the polyolefin (b), of which propylene polymers are especially preferred, for satisfactory moldability.

Such ethylene polymers preferably used as the polyolefin (b) include, for example, high-density polyethylenes, medium-density polyethylenes, low-density polyethylenes, and other ethylene homopolymers; ethylene-butene-1 copolymers, ethylene-hexene copolymers, ethylene-heptene copolymers, ethylene-octene copolymers, ethylene-4-methylpentene-1 copolymers, ethylene-vinyl acetate copolymers, ethylene-acrylic acid copolymers, ethylene-acrylate copolymers, ethylene-methacrylic acid copolymers, ethylene-methacrylate copolymers, and other ethylene copolymers. Among them, high-density polyethylenes, medium-density polyethylenes, and/or low-density polyethylenes are more preferred for further satisfactory moldability.

Such propylene polymers preferably used as the polyolefin (b) include, for example, propylene homopolymers; ethylene-propylene random copolymers, ethylene-propylene block copolymers, propylene-butene-1 copolymers, propylene-ethylene-butene-1 copolymers, and propylene-4-methylpentene-1 copolymers. Among them, propylene homopolymers, ethylene-propylene random copolymers and/or ethylene-propylene block copolymers are more preferred for further satisfactory moldability.

The thermoplastic elastomer composition of the present invention must comprise the polyolefin component, typically in an amount up to about 300 parts by weight of the polyolefin component (b) relative to 100 parts by weight of the addition block copolymer (a), and more typically from about 10 to about 300 parts by weight.

In one embodiment, the polyolefin component (b) is present in at least an amount such that the vulcanizable thermoplastic elastomer composition has a morphological structure in which the polyolefin component (b) forms a continuous phase, and fine particles of the addition block copolymer (a) are dispersed therein. The diameter of dispersed particles in the finely dispersed phase is desirably from about 0.1 μm to about 30 μm, or to about 10 μm. This allows strain recovery at high temperatures, flexible rubber properties, and satisfactory moldability to be imparted to the vulcanized thermoplastic elastomer composition.

The morphological structure of the vulcanized thermoplastic elastomer composition is not limited to the aforementioned one, and it is also acceptable that a phase comprising the addition block copolymer (a) and the rubber softener (c), and a phase comprising the polyolefin component (b) constitute a co-continuous phase in the vulcanized thermoplastic elastomer composition of the present invention.

Typically, when the content of the polyolefin component (b) is less than about 10 parts by weight, the resulting vulcanized thermoplastic elastomer composition will have insufficient thermoplasticity and deteriorated moldability. Typically, if the polyolefin component exceeds about 300 parts by weight, the thermoplastic elastomer composition will have insufficient flexibility, For further satisfactory moldability, flexibility, and other properties, the thermoplastic elastomer composition of the present invention can comprise from about 12, or from about 14, to about 200, or to about 100, parts by weight of the polyolefin component (b) relative to 100 parts by weight of the addition block copolymer (a).

### Rubber Softener Component (c)

The rubber softener (c) for use in the thermoplastic elastomer composition of the present invention is not specifically limited in its type or species and can be any of mineral oil softeners and/or synthetic resin softeners. Such mineral oil softeners are generally mixtures of aromatic hydrocarbons, naphthene hydrocarbons and paraffin hydrocarbons. Those in which carbon atoms constituting paraffin hydrocarbons occupy 50% by number or more of the total carbon atoms are called “paraffin oils”. Those in which carbon atoms constituting naphthene hydrocarbons occupy 30 to 45% by number of the total carbon atoms are called “naphthene oils”. Those in which carbon atoms constituting aromatic hydrocarbons occupy 35% by number or more of the total carbon atoms are called “aromatic oils”. Among them, paraffin oils are preferably used as the rubber softener in the present invention.

Such paraffin oils desirably have a kinematic viscosity at 40° C. of preferably from about 20 cSt (centistokes), or from about 50 cSt, to about 800 cSt, or to about 600 cSt; a pour point of from about 0° C. to about −40° C., or to about −30° C.; and a flash point of from about 200° C., or from about 250° C., to about 400° C., or to about 350° C., as determined by the Cleveland Open Cup (COC) method.

The synthetic resin softeners can be any of, for example, polybutenes and low-molecular-weight polybutadienes except for the liquid diene rubbers illustrated as a crosslinking co-agent (e).

The vulcanizable thermoplastic elastomer composition of the present invention comprises from about 10, or from about 50, to about 300, or to about 250, parts by weight of the rubber softener component (c) relative to 100 parts by weight of the addition block copolymer (a).

### Crosslinking Agent (d)

The crosslinking agent (d) comprises a peroxide, and can be any peroxide so as long as it react with the relevant structural units in the addition block copolymer (a) during dynamic vulcanization to thereby form crosslinks in situ.

The crosslinking agent (d) can be appropriately selected in view of reactivity depending on treatment conditions such as treatment temperature and treatment time in the dynamic vulcanization.

By using an organic peroxide as the crosslinking agent (d), the resulting addition block copolymer (a) will be crosslinked at least to some extent both in the polymer block (A) and in the polymer block (B), regardless of whether or not an unsaturated bond is present in the polymer block (B).

The organic peroxide can be any of organic peroxides. Such organic peroxides include, for example, dicumyl peroxide, di-t-butyl peroxide, 2,5-dimethyl-2,5-di(t-butylperoxy)hexane, 2,5-dimethyl-2,5-di(t-butylperoxy)hexyne-3, 1,3-bis(t-butylperoxyisopropyl)benzene, 1,1 -bis(t-butylperoxy)-3,3,5-trimethylcyclohexane, n-butyl-4,4-bis(t-butylperoxy)valerate, benzoyl peroxide, p-chlorobenzoyl peroxide, 2,4-dichlorobenzoyl peroxide, t-butyl peroxybenzoate, t-butyl peroxyisopropylcarbonate, diacetyl peroxide, lauroyl peroxide, and t-butyl cumyl peroxide. Each of these organic peroxides can be used alone or in combination. Among them, 2,5-dimethyl-2,5-di(t-butylperoxy)hexane and dicumyl peroxide are preferably used for their reactivity.

If the addition block copolymer (a) contains other functional groups, other crosslinking agents may be used corresponding to the type of the other functional group in the addition block copolymer (a).

When the other functional group is a functional group having an active hydrogen atom, such as a hydroxyl group, —SH, —NH₂, —NHR, —CONH₂, —CONHR, —CONH—, —SO₃H, —SO₂H, and —SOH, the other crosslinking agent can be isocyanate compounds such as monomeric isocyanate, isocyanate adducts such as aliphatic, alicyclic, aromatic, and biphenyl isocyanate adducts, and block isocyanates. Among them, preferred are polyisocyanate compounds each having two or more, preferably three or more, isocyanate groups. Such polyisocyanates include polyisocyanates having isocyanurate bonds and being prepared from hexamethylene diisocyanate. In this case, a tin catalyst, a titanium catalyst or another catalyst can be used for improving the reactivity between the isocyanate-compound crosslinking agent and the other functional group in the addition block copolymer (a).

When the other functional group is a hydroxyl group, the other crosslinking agent can be, for example, polyepoxy compounds, maleic anhydride, pyromellitic anhydride, and other polycarboxylic anhydrides, in addition to the isocyanate compounds.

When the other functional group is a carboxyl group, the other crosslinking agent can be, for example, polyepoxy compounds and polyamines.

When the other functional group is an epoxy group, the other crosslinking agent can be, for example, polycarboxylic acids and polyamines.

### Crosslinking Co-Agent (e)

In accordance with the present invention, a liquid diene rubber crosslinking co-agent is used in addition to the peroxide crosslinking agent.

Typically, the liquid diene rubber is a polymer that contains isoprene and/or butadiene units in an amount of not less than 50 mass % relative to all the monomer units constituting the polymer. The isoprene/butadiene unit content is preferably 60 to 100 mass %, and more preferably 70 to 100 mass % relative to all the monomer units forming the liquid diene rubber.

In one embodiment, the liquid diene rubber is an isoprene homopolymer. In another embodiment, the liquid diene rubber is a butadiene homopolymer. In another embodiment, the liquid diene polymer is a copolymer of only isoprene and butadiene.

In other embodiments, the liquid diene rubber may contain other monomer units such as units of conjugated dienes other than isoprene and butadiene, and units of aromatic vinyl compounds.

Examples of the other conjugated dienes include 2,3-dimethylbutadiene, 2-phenylbutadiene, 1,3-pentadiene, 2-methyl-1,3-pentadiene, 1,3-hexadiene, 1,3-octadiene, 1,3-cyclohexadiene, 2-methyl-1,3-octadiene, 1,3,7-octatriene, myrcene and chloroprene. The other conjugated dienes may be used singly, or two or more may be used in combination.

Examples of the aromatic vinyl compounds include styrene, α-methylstyrene, 2-methylstyrene, 3 -methylstyrene, 4-methylstyrene, 4-propylstyrene, 4-t-butylstyrene, 4-cyclohexylstyrene, 4-dodecylstyrene, 2,4-dimethylstyrene, 2,4-diisopropylstyrene, 2,4,6-trimethylstyrene, 2-ethyl-4-benzylstyrene, 4-(phenylbutyl)styrene, 1-vinylnaphthalene, 2-vinylnaphthalene, vinylanthracene, N,N-diethyl-4-aminoethylstyrene, vinylpyridine, 4-methoxystyrene, monochlorostyrene, dichlorostyrene and divinylbenzene. When used, styrene, α-methylstyrene and 4-methylstyrene are preferable.

In the liquid diene rubber, the content of the monomer units other than the isoprene and butadiene units is preferably not more than 50 mass %, or not more than 40 mass %, or not more than 30 mass %.

The vinyl content of the liquid diene rubber is preferably from about 3 mol %, or from about 10 mol %, or from about 30 mol %, or from about 35 mol %, or from about 40 mol %, or from about 45 mol %, or from about 50 mol %, or from about 55 mol %, or from about 60 mol %, or from about 65 mol %, to about 90 mol %, or to about 70 mol %. The vinyl content is the mole proportion of the vinyl units based on the all structural units constituting the liquid diene rubber. An isopropenylethylene group and a 1-methyl-1-vinylethylene group correspond to the vinyl units for isoprene unit, and a vinylethylene group for butadiene unit.

The liquid diene rubber can be prepared by well-known processes, for example, by polymerizing isoprene and/or butadiene and/or optionally additional monomers by a process such as, for example, emulsion polymerization or solution polymerization.

The emulsion polymerization process is generally known to those of ordinary skill in the relevant art. For example, monomers including a prescribed amount of the conjugated diene may be emulsified and dispersed in the presence of an emulsifier and may be emulsion polymerized with use of a radical polymerization initiator. Examples of the emulsifiers include long-chain fatty acid salts having 10 or more carbon atoms, and rosin acid salts. Examples of the long-chain fatty acid salts include potassium salts and sodium salts of fatty acids such as capric acid, lauric acid, myristic acid, palmitic acid, oleic acid and stearic acid.

Usually, water is used as a dispersant. The dispersant may include a water-soluble organic solvent such as methanol or ethanol as long as the stability during the polymerization is not impaired.

Examples of the radical polymerization initiators include persulfate salts such as ammonium persulfate and potassium persulfate, organic peroxides and hydrogen peroxide.

To control the molecular weight of the liquid diene rubber, a chain transfer agent may be used. Examples of the chain transfer agents include mercaptans such as t-dodecylmercaptan and n-dodecylmercaptan; carbon tetrachloride, thioglycolic acid, diterpene, terpinolene, γ-terpinene and α-methylstyrene dimer.

The temperature of the emulsion polymerization may be selected appropriately in accordance with, for example, the type of the radical polymerization initiator used. The temperature is usually in the range of from about 0° C. to about 100° C., or to about 60° C. The polymerization mode may be continuous or batchwise.

The polymerization reaction may be terminated by the addition of a polymerization terminator. Examples of the polymerization terminators include amine compounds such as isopropylhydroxylamine, diethylhydroxylamine and hydroxylamine, quinone compounds such as hydroquinone and benzoquinone, and sodium nitrite.

The termination of the polymerization reaction may be followed by the addition of an antioxidant as required. After the termination of the polymerization reaction, the emulsion obtained is cleaned of the unreacted monomers as required, and the liquid diene rubber is coagulated by the addition of a coagulant salt such as sodium chloride, calcium chloride or potassium chloride optionally together with an acid such as nitric acid or sulfuric acid to control the pH of the coagulated system to a prescribed value. The dispersion solvent is then separated, thereby recovering the polymer. Next, the polymer is washed with water, dehydrated and dried.

During the coagulation process, the resulting emulsion may be mixed together with an emulsified dispersion of an extender oil as required, and the liquid diene rubber may be recovered as an oil-extended rubber.

The solution polymerization process may be a known process or a process that is deemed as known. For example, monomers including the conjugated diene are polymerized in a solvent with a Ziegler catalyst, a metallocene catalyst or an active metal or an active metal compound capable of catalyzing anionic polymerization, optionally in the presence of a polar compound as desired.

Examples of suitable solvents include aliphatic hydrocarbons such as n-butane, n-pentane, isopentane, n-hexane, n-heptane and isooctane; alicyclic hydrocarbons such as cyclopentane, cyclohexane and methylcyclopentane; and aromatic hydrocarbons such as benzene, toluene and xylene.

Examples of the active metals capable of catalyzing anionic polymerization include alkali metals such as lithium, sodium and potassium; alkaline-earth metals such as beryllium, magnesium, calcium, strontium and barium; and lanthanoid rare earth metals such as lanthanum and neodymium. Of the active metals capable of catalyzing anionic polymerization, alkali metals and alkaline-earth metals are preferable, and alkali metals are more preferable.

Preferred active metal compounds capable of catalyzing anionic polymerization are organoalkali metal compounds. Examples of the organoalkali metal compounds include organomonolithium compounds such as methyllithium, ethyllithium, n-butyllithium, sec-butyllithium, t-butyllithium, hexyllithium, phenyllithium and stilbenelithium; polyfunctional organolithium compounds such as dilithiomethane, dilithionaphthalene, 1,4-dilithiobutane, 1,4-dilithio-2-ethylcyclohexane and 1,3,5-trilithiobenzene; sodium naphthalene and potassium naphthalene. Of these organoalkali metal compounds, organolithium compounds are preferable, and organomonolithium compounds are more preferable.

The amount in which the organoalkali metal compounds are used may be determined appropriately in accordance with factors such as the melt viscosity and molecular weight of the liquid diene rubber. Usually, the amount of such compounds is 0.01 to 3 parts by mass per 100 parts by mass of all the monomers including the conjugated diene.

The organoalkali metal compound may be used in the form of an organoalkali metal amide by being subjected to a reaction with a secondary amine such as dibutylamine, dihexylamine or dibenzylamine.

The polar compounds are usually used for the purpose of controlling the microstructure of conjugated diene moieties without deactivating the anionic polymerization reaction. Examples of the polar compounds include ether compounds such as dibutyl ether, tetrahydrofuran and ethylene glycol diethyl ether; tertiary amines such as tetramethylethylenediamine and trimethylamine; alkali metal alkoxides and phosphine compounds. The polar compounds are usually used in an amount of 0.01 to 1,000 mol relative to the organoalkali metal compound.

The temperature of the solution polymerization is usually in the range of from about −80° C., or from about 0° C., or from about 10° C., to about 150° C., or to about 100° C., or to about 90° C. The polymerization mode may be batchwise or continuous.

The polymerization reaction may be terminated by the addition of a polymerization terminator. Examples of the polymerization terminators include alcohols such as methanol and isopropanol. The liquid diene rubber may be isolated by pouring the polymerization reaction liquid into a poor solvent such as methanol to precipitate the liquid diene rubber, or by washing the polymerization reaction liquid with water followed by separation and drying.

Of the processes for producing the liquid diene rubber described hereinabove, the solution polymerization process is particularly preferable.

The liquid diene rubbers suitable for use in the present invention typically have an Mn in the range of from about 1,000, or from about 3,000, or from about 4,000, to about 100,000, or to about 60,000, or to about 30,000, or to about 15,000.

The liquid diene rubbers suitable for use in the present invention also typically have a molecular weight distribution (Mw/Mn) in the range of from about 1.0 to about 2.0, or to about 1.5, or to about 1.3, or to about 1.2, or to about 1.1.

Such liquid diene rubbers may also have a glass transition temperature ranging from about −100° C., or from about −80° C., or from about −70° C., to about 30° C., or to about 0° C., or to about −20° C., as measured by the following method. Ten milligrams (10 mg) of the material are sampled in an aluminum pan, and a thermogram of the sample is obtained at temperature rise rate of 10° C./min by differential scanning calorimetry (DSC). The value at a peak top observed in the DDSC curve is determined as a glass transition temperature of the material.

The liquid diene rubber should be flowable (not solid) under ambient conditions (for example, at 20° C.).

Such liquid diene rubbers may also have a melt viscosity ranging from about 0.1 Pa·s, or from about 0.5 Pa·s, or from about 1 Pa·s, or from about 2.5 Pa·s, to about 3,000 Pa·s, or to about 600 Pa·s, or to about 300 Pa·s, or to about 100 Pa·s, or to about 50 Pa·s, or to about 10 Pa·s, as measured at 38° C. using a Brookfield viscometer (Brookfield Engineering Labs. Inc.).

As indicated above, the liquid diene rubber is desirably “unmodified”, that is, not modified with functional or terminal groups as disclosed in some of the above-incorporated references.

Such liquid diene rubbers are in a general sense well known to those of ordinary skill in the relevant art, as exemplified by U.S. Pat. No. 4,204,046, U.S. Pat. No. 5,760,135, U.S. Pat. No. 6,562,895B2, US2006/0189720A1, US2010/0152368A1, US2016/0053097A1, US2016/0229927A1 and US2017/0009065A1. Commercially available suitable liquid diene rubbers include KL-10, LIR-30, LIR-50, LIR-310, LIR-390, LIR-290, LBR-302, LBR-307, LBR-305, LBR-300, LBR-352, LBR-361, L-SBR-820 and L-SBR-841 (Kuraray Co., Ltd., Tokyo, JP).

In addition to the liquid diene rubber, minor amounts of other crosslinking co-agents may be used as well. Such other crosslinking co-agents include, for example, benzothiazyl disulfide, tetramethylthiuram disulfide and other disulfide compounds, triallyl isocyanurate, divinylbenzene, ethylene glycol dimethacrylate, triethylene glycol dimethacrylate, and other polyfunctional monomers. Desirably, such other co-crosslinking agents, and in particular triallyl isocyanurate, are not used.

### Amounts of Peroxide and Liquid Diene Rubber

The amount of the peroxide crosslinking agent (d) is preferably from about 0.01, or from about 0.5, or from about 1, to about 20, or to about 10 parts by weight, relative to 100 parts by weight of the addition block copolymer (a).

The amount of the liquid diene rubber co-agent (e) is from about 1, or from about 2.5, to about 50, or to about 30 parts by weight, relative to 100 parts by weight of the addition block copolymer (a).

The weight ratio of peroxide crosslinking agent (d)/liquid diene rubber co-agent (e) is from about 0.01, or from about 0.02, or from about 0.05, or from about 0.1, to about 1, or to about 0.75.

### Optional Components

The thermoplastic elastomer compositions of the present invention may further comprise other polymers within ranges not deteriorating the advantages of the present invention. Such other polymers for use herein may include, for example, poly(phenylene ether) resins; polyamide 6, polyamide 6.6, polyamide 6.10, polyamide 11, polyamide 12, polyamide 6.12, poly(hexamethylenediamine terephthalamide), poly(hexamethylenediamine isophthalamide), xylene-group-containing polyamides, and other polyamide resins; poly(ethylene terephthalate), poly(butylene terephthalate), and other polyester resins; poly(methyl acrylate), poly(methyl methacrylate), and other acrylic resins; polyoxymethylene homopolymers, polyoxymethylene copolymers, and other polyoxymethylene resins; styrene homopolymers, acrylonitrile-styrene resins, acrylonitrile-butadiene-styrene resins, and other styrenic resins; polycarbonate resins; ethylene-propylene copolymer rubbers (EPM), ethylene-propylene-non-conjugated diene terpolymer rubbers (EPDM), and other ethylenic elastomers; styrene-butadiene copolymer rubber, styrene-isoprene copolymer rubbers, and other styrenic elastomers, hydrogenated products and modified products thereof; natural rubbers; synthetic isoprene rubbers, hydrogenated products and modified products thereof; chloroprene rubbers; acrylic rubbers; isobutylene-isoprene rubbers (butyl rubbers); acrylonitrile-butadiene rubbers; epichlorohydrin rubbers; silicone rubbers; fluorocarbon rubbers; chlorosulfonated polyethylenes; urethane rubbers; polyurethane elastomers; polyamide elastomers; polyester elastomers; and plasticized vinyl chloride resins.

The content of the other polymers is preferably within ranges not adversely affecting the flexibility and mechanical properties of the resulting thermoplastic elastomer composition and is preferably 200 parts by weight or less relative to 100 parts by weight of the addition block copolymer (a).

The thermoplastic elastomer composition of the present invention may further comprise inorganic fillers. Such inorganic fillers for use in the thermoplastic elastomer composition of the present invention include, for example, calcium carbonate, talc, clay, synthetic silicon, titanium oxide, carbon black, barium sulfate, mica, glass fibers, whiskers, carbon fibers, magnesium carbonate, glass powders, metal powders, kaolin, graphite, molybdenum disulfide, and zinc oxide. Each of these inorganic fillers can be used alone or in combination. The content of the organic fillers is preferably within ranges not deteriorating performance of the resulting thermoplastic elastomer and is generally about 50 parts by weight or less relative to 100 parts by weight of the addition block copolymer (a).

The thermoplastic elastomer composition of the present invention may further comprise, according to necessity, one or more of lubricants, light stabilizers, pigments, heat stabilizers, anti-fogging agents, flame retarders, antistatic agents, silicone oils, antiblocking agents, UV absorbers, and antioxidants. Examples of such antioxidants are hindered phenol antioxidants, hindered amine antioxidants, phosphorus-containing antioxidants, and sulfur-containing antioxidants.

### Preparation of Compositions

The thermoplastic elastomer compositions of the present invention may be produced by mixing the various components via techniques well known to those of ordinary skill in the relevant art, for example, in a Henschel mixer, a tumbler, a ribbon blender and the like. Intimate mixing is highly desirable to result in a uniform blend of the components to ensure uniformity of crosslinking on vulcanization.

The vulcanized thermoplastic elastomer composition of the present invention is preferably produced by the following process. The process includes the step of dynamic vulcanization (dynamic crosslinking) of a mixture under melting conditions, which mixture is obtained by adding the polyolefin (b), rubber softener (c), peroxide crosslinking agent (d) and liquid diene rubber co-agent (e) with, where desired, the aforementioned other polymers and/or additives, to the addition block copolymer (a).

The term “dynamic vulcanization” as used herein means subjecting the mixture under melting conditions to kneading to thereby crosslink the mixture with the application of shearing force.

The dynamic vulcanization process for the production of the thermoplastic elastomer composition of the present invention converts the addition block copolymer (a) into an addition block copolymer which is crosslinked by action of the peroxide crosslinking agent (d) and liquid diene rubber co-agent (e).

For dynamic vulcanization, any machine can be used as long as it is a melt kneading machine capable of mixing individual components homogeneously. Such melt kneading machines include, for example, single-screw extruders, twin-screw extruders, kneaders, and Banbury mixers. Twin-screw extruders that can exhibit a great shearing force during kneading and can be operated continuously are preferably used.

Although not specifically limited, the dynamic vulcanization process using an extruder for the production of the thermoplastic elastomer composition under melting conditions can be performed, for example, in the following manner.

Initially, the addition block copolymer (a) and polyolefin (b) are mixed and fed into a hopper of an extruder. In this step, the polyolefin (b), rubber softener (c), peroxide crosslinking agent (d) and liquid diene rubber co-agent (e) are initially added to addition block copolymer (a), or a part or all of them are added at some middle portion of the extruder, and the components are melted, kneaded and extruded. Another possible option is to perform the melt kneading stepwise by using two or more extruders.

The melt kneading temperature can be appropriately selected within ranges in which the addition block copolymer (a) and the polyolefin (b) are melted, and the crosslinking agent (d) and liquid diene rubber co-agent (e) react. Typically this is from about 160° C., or from about 180° C., to about 270° C., or to about 240° C. The melt kneading time is typically from about 30 seconds to about 5 minutes.

The thermoplastic elastomer composition of the present invention obtained by the dynamic vulcanization under melting conditions as above generally has a specific morphological structure in which a phase comprising the crosslinked addition block copolymer (a), rubber softener (c) and liquid diene rubber (e) (in free form or chemically bonded to addition block copolymer (a)) is finely dispersed in a continuous phase (matrix phase) comprising the polyolefin (b). The dispersed particles of the finely dispersed phase have a diameter of typically from about 0.1 μm to about 30 μm, or to about 10 μm. However, the morphological structure is not limited to the aforementioned one, and it is also acceptable that a phase comprising the polyolefin (b) and a phase comprising the other components constitute a co-continuous phase in the thermoplastic elastomer composition of the present invention. The composition obtained in this case can have excellent thermoplasticity by appropriately setting the amount of the crosslinking agent (d) and liquid diene rubber (e), and kneading conditions.

### Molded Articles

The thus-obtained vulcanized thermoplastic elastomer composition of the present invention has excellent moldability and can be molded or processed by a molding procedure such as injection molding, extrusion molding, inflation molding, T-die film molding, laminate molding, blow molding, hollow molding, compression molding, and calendering.

Molded articles obtained by molding the thermoplastic elastomer composition of the present invention can be used in various applications. For example, the molded articles can be used in instrumental panels, center panels, center console boxes, door trims, pillars, assist grips, steering wheels, airbag covers, air ducts, and other interior automotive trims; weather strips, bumpers, moldings, sealing materials between glass and frames, and other exterior automotive trims; bumpers for vacuum cleaners, remote control switches, key tops of office automation equipment, TV apparatus, stereos, and other home-appliance parts; hydroscopes, underwater camera covers, and other underwater products; covering parts, industrial parts with packing, for example, for sealing, waterproofing, soundproofing, and vibration isolation; racks, pinion boots, suspension boots, constant velocity joint boots; and other automotive functional parts; belts, hoses, tubes; wire covering, silencer gears, and other electric/electronic parts; sporting goods; sundry goods; stationery; doors, window frame materials, and other construction materials; joints; valve parts; gaskets for medical syringes, bags, tubes, and other medical appliances; hot melt sealing materials; rubber threads, stretchable films, and other stretchable materials; wires, cables, and other articles.

### EXAMPLES

The present invention will be illustrated in further detail with reference to examples, and comparative examples below, which are not intended to limit the scope of the invention. Physical properties and qualities of molded articles in the examples, comparative examples, reference examples, and comparative examples were determined according to the following methods.

(1) Determination of Hardness (JIS-A). Plural plies of a press sheet of a thermoplastic elastomer composition were stacked to a set thickness (12 mm), and A-type hardness was determined according to Japanese Industrial Standard (JIS) K6301.

(2) Determination of Melt Index (MI). MI was determined according to JIS K7210, with the melt flow rate (MFR) of the pellets being measured at 230° C. under a 10 kg load.

(3) Determination of Compression Set. A press sheet of a thermoplastic elastomer composition was left standing for 22 hours at a temperature of 120° C. and at a compressive deformation of 25% according to JIS K6301, and the compression set of the press sheet was determined.

(4) Determination of Odor. A press sheet of a thermoplastic elastomer composition was subjectively evaluated for its odor by five monitors according to the following criteria: weak (slight smell) and strong (stronger smell).

(5) Determination of Tensile Strength and Tensile Elongation at Break. A JIS #3 dumbbell specimen was cut from a press sheet of a thermoplastic elastomer composition, and the tensile strength at break and the tensile elongation at break of the specimen were determined at 500 mm/min according to JIS K6301 using an Autograph (Shimadzu Corporation). Each of the tensile strength at break and the tensile elongation at break were measured in both the machine direction (MD) and the transverse direction (TD) of the press sheet.

The addition block copolymers (a), polyolefins (b), rubber softeners (c), peroxide crosslinking agents (d) and liquid diene rubber co-agents (e) and comparative co-agents used in the following examples, and comparative examples are as follows.

Addition Block Copolymer (a1)—a hydrogenated product of the poly(p-methylstyrene-co-styrene)-poly(isoprene-co-butadiene)-poly(p-methylstyrene-co-styrene) triblock copolymer (A-B-A type triblock copolymer), which does not have any functional groups. The content of the p-methylstyrene-derived structural unit in the total blocks (A) is 40% by weight. The weight proportions of the blocks (A)/(B)/(A) in the addition block copolymer before hydrogenation is 15/70/15. The hydrogenation ratio in the polymer block (B) is 98.3 mol % determined by measuring an iodine value. The number-average molecular weight of the addition block copolymer after hydrogenation is 278,000.

Polyolefin (b1)—a polypropylene homopolymer sold under the trade designation P4G2Z-159 (Flint Hills Resources, Longview, Tex. USA).

Rubber Softener (c1)—a paraffinic oil softener sold under the trade designation PW-90 (Idemitsu Kosan Co., Ltd., Japan).

Peroxide Crosslinker (d1)—2,2′-bis(tert-butylperoxy)diisopropyl benzene sold under the trade designation VAROX 802-40KE (Vanderbilt Chemicals, LLC).

Liquid Diene Rubber Co-Agent (e1)—a liquid unmodified polybutadiene homopolymer rubber having a vinyl content of 66.1 mol %, Mn of 4,400, a molecular weight distribution (Mw/Mn) of 1.04, Tg of −49° C., and a melt viscosity (38° C.) of 3.2 Pa·s.

Comparative Co-Agent (COMP1)—a triallyl isocyanurate sold under the trade designation Sartomer SR 533 (Sartomer USA, Exton, Pa. USA).

### Examples 1 to 4 and Comparative Examples 1 to 3

(1) Addition block copolymer (a1), polyolefin (b1), rubber softener (c1), peroxide crosslinking agent (d1) and the co-agent (e1 or COMP1) were premixed in proportions shown in Table 1 below, and the resulting mixtures were fed to a twin screw extruder (TEM-35B, Toshiba Machine Co., Ltd.), were melted and kneaded at a temperature of 200° C., and thereby yielded a series of vulcanized thermoplastic elastomer compositions.

(2) Using the vulcanized thermoplastic elastomer compositions obtained in (1) above, molded articles (press sheets) 150 mm wide, 150 mm long and 1 mm thick were produced by molding at a mold temperature of 210° C. using a press molding machine (a single acting compression molding machine “NSF-37” available from Shinto Metal Industries, Ltd.).

The physical properties of the molded articles were determined according to the above-mentioned methods, and the results are shown in Table 1 below.

TABLE 1

| | Ex. 1 | Ex. 2 | Ex. 3 | Ex. 4 | CEx. 1 | CEx. 2 | CEx. 3 |
|---|---|---|---|---|---|---|---|
| Addition block copolymer (a1) | 100 | 100 | 100 | 100 | 100 | 100 | 100 |
| Softener (c1) | 100 | 100 | 100 | 100 | 100 | 100 | 100 |
| Polyolefin (b1) | 27.3 | 27.3 | 27.3 | 27.3 | 27.3 | 27.3 | 27.3 |
| Peroxide (d1) | 3.5 | 3.5 | 3.5 | 3.5 | 3.5 | 3.5 | 3.5 |
| Co-agent (COMP1) | | | | | 4.5 | 5.4 | 6 |
| Co-Agent (e1) | 4.5 | 8 | 15 | 24 | | | |
| Hardness (Shore A) | 53 | 55 | 60 | 62 | 55 | 51 | 59 |
| MI (g/10 min) 230° C. 10 kg | 11.4 | 13.0 | 10.4 | 1.8 | 19.4 | | |
| C Set (%) 120° C. for 22 hrs | 38 | 38 | 34 | 31 | 34 | 37 | 35 |
| Odor | weak | weak | weak | weak | strong | strong | strong |
| Tensile strength (MPa) Machine direction | 5.1 | 6.1 | 5.5 | 5.4 | 4.8 | 4.7 | 5 |
| Elongation at brk (%) Machine direction | 342 | 375 | 291 | 232 | 279 | 267 | 228 |
| Tensile strength (MPa) Transverse direction | 6.4 | 7 | 6.7 | 6.8 | 5.4 | 5.9 | 6.2 |
| Elongation at brk (%) Transverse direction | 458 | 440 | 386 | 334 | 327 | 347 | 296 |

We claim:

1. A vulcanizable composition comprising a mixture of:
(a) 100 parts by weight of an addition block copolymer thermoplastic elastomer having at least one polymer block (A) comprising units derived from an aromatic vinyl compound, and at least one polymer block (B) comprising units derived from a conjugated diene compound;
(b) a polyolefin component in an amount of from about 10 to about 300 parts by weight;
(c) a rubber softener component in an amount of from about 10 to about 300 parts by weight;
(d) a peroxide crosslinking agent in an amount of from about 0.01 to about 10 parts by weight; and
(e) a crosslinking co-agent,
wherein the crosslinking co-agent comprises a liquid diene rubber in an amount of from about 1 to about 50 parts by weight, and
the weight ratio of the peroxide crosslinking agent to the liquid diene rubber is from about 0.01 to about 1.

2. The vulcanizable composition of claim 1, wherein the block (A) comprises units derived from at least one alkylstyrene compound having an alkyl group containing from 1 to 8 carbon atoms.

3. The vulcanizable composition of claim 2, wherein (i) the alkylstyrene compound comprises a p-methylstyrene compound, or (ii) the conjugated diene compound comprises butadiene, isoprene or a mixture thereof, or (iii) the addition block copolymer is at least partially hydrogenated, or (iv) a combination of (i), (ii) and (iii).

4. The vulcanizable composition of claim 1, wherein the mixture is a substantially uniform mixture.

5. The vulcanizable composition of claim 1, wherein the liquid diene rubber is an unmodified liquid diene rubber.

6. The vulcanizable composition of claim 1, wherein the liquid diene rubber is an isoprene homopolymer, a butadiene homopolymer, or a copolymer of only isoprene and butadiene.

7. The vulcanizable composition of claim 1, wherein (i) the liquid diene rubber has a vinyl content of from about 35 mol % to about 90 mol %, or (ii) the liquid diene rubber has an Mn in the range of from about 1,000 to about 100,000, and a molecular weight distribution (Mw/Mn) in the range of from about 1.0 to about 2.0, or (iii) the liquid diene rubber has a glass transition temperature ranging from about −100° C. to about 30° C., or (iv) a combination of (i), (ii) and (iii).

8. A composition comprising a mixture of:
(a) 100 parts by weight of an addition block copolymer thermoplastic elastomer having at least one polymer block (A) comprising units derived from an aromatic vinyl compound, and at least one polymer block (B) comprising units derived from a conjugated diene compound, wherein the block copolymer is crosslinked in both the blocks (A) and (B);
(b) a polyolefin component in an amount of from about 10 to about 300 parts by weight;
(c) a rubber softener component in an amount of from about 10 to about 300 parts by weight; and
(d) a liquid diene rubber in an amount of from about 1 to about 50 parts by weight,
wherein at least a portion of the liquid diene rubber is chemically bonded to the addition block copolymer, and
the composition is thermoplastic, elastic and moldable.

9. The composition of claim 8, wherein the block (A) comprises units derived from at least one alkylstyrene compound having an alkyl group containing from 1 to 8 carbon atoms.

10. The composition of claim 9, wherein (i) the alkylstyrene compound comprises a p-methylstyrene compound, or (ii) the conjugated diene compound comprises butadiene, isoprene or a mixture thereof, or (iii) the addition block copolymer is at least partially hydrogenated, or (iv) a combination of (i), (ii) and (iii).

11. The composition of claim 8, wherein the composition has a morphological structure in which the polyolefin component forms a continuous phase.

12. The composition of claim 8, wherein the mixture is a substantially uniform mixture.

13. The composition of claim 8, wherein the liquid diene rubber is an unmodified liquid diene rubber.

14. The composition of claim 8, wherein the liquid diene rubber is an isoprene homopolymer, a butadiene homopolymer, or a copolymer of only isoprene and butadiene.

15. An article molded from the composition of claim 8.

16. A process for preparing a moldable thermoplastic elastomer composition, comprising the steps of:
(1) mixing (a) an addition block copolymer thermoplastic elastomer having at least one polymer block (A) comprising units derived from an aromatic vinyl compound, and at least one polymer block (B) comprising units derived from a conjugated diene compound, (b) a polyolefin, (c) a rubber softener, (d) a peroxide crosslinking agent, and (e) a crosslinking co-agent, to form a pre-blend, and
(2) dynamically vulcanizing the pre-blend under shear and elevated temperature conditions to form crosslinks in both the blocks (A) and (B),
wherein the pre-blend is the vulcanizable composition of claim 1, and
the dynamically vulcanizing step is conducted under conditions such that at least a portion of the liquid diene rubber chemically bonds to the addition block copolymer.

17. The process of claim 16, wherein the pre-blend is a vulcanizable composition, comprising a mixture of:
(a) 100 parts by weight of an addition block copolymer thermoplastic elastomer having at least one polymer block (A) comprising units derived from an aromatic vinyl compound, and at least one polymer block (B) comprising units derived from a conjugated diene compound;
(b) a polyolefin component in an amount of from about 10 to about 300 parts by weight;
(c) a rubber softener component in an amount of from about 10 to about 300 parts by weight;
(d) a peroxide crosslinking agent in an amount of from about 0.01 to about 10 parts by weight; and
(e) a crosslinking co-agent,
wherein the crosslinking co-agent comprises a liquid diene rubber in an amount of from about 1 to about 50 parts by weight,
the liquid diene rubber is an unmodified liquid diene rubber, and
the weight ratio of the peroxide crosslinking agent to the liquid diene rubber is from about 0.01 to about 1.

18. The process of claim 16, wherein the pre-blend is a vulcanizable composition, comprising:
(a) 100 parts by weight of an addition block copolymer thermoplastic elastomer having at least one polymer block (A) comprising units derived from an aromatic vinyl compound, and at least one polymer block (B) comprising units derived from a conjugated diene compound;
(b) a polyolefin component in an amount of from about 10 to about 300 parts by weight;
(c) a rubber softener component in an amount of from about 10 to about 300 parts by weight;
(d) a peroxide crosslinking agent in an amount of from about 0.01 to about 10 parts by weight; and
(e) a crosslinking co-agent,
wherein the crosslinking co-agent comprises a liquid diene rubber in an amount of from about 1 to about 50 parts by weight,
the liquid diene rubber is an isoprene homopolymer, a butadiene homopolymer, or a copolymer of only isoprene and butadiene, and
the weight ratio of the peroxide crosslinking agent to the liquid diene rubber is from about 0.01 to about 1.

19. The process of claim 16, wherein the pre-blend is the vulcanizable composition, comprising:
(a) 100 parts by weight of an addition block copolymer thermoplastic elastomer having at least one polymer block (A) comprising units derived from an aromatic vinyl compound, and at least one polymer block (B) comprising units derived from a conjugated diene compound;
(b) a polyolefin component in an amount of from about 10 to about 300 parts by weight;
(c) a rubber softener component in an amount of from about 10 to about 300 parts by weight;
(d) a peroxide crosslinking agent in an amount of from about 0.01 to about 10 parts by weight; and
(e) a crosslinking co-agent,
wherein the crosslinking co-agent comprises a liquid diene rubber in an amount of from about 1 to about 50 parts by weight,
(i) the liquid diene rubber has a vinyl content of from about 35 mol % to about 90 mol %, or (ii) the liquid diene rubber has an Mn in the range of from about 1,000 to about 100,000, and a molecular weight distribution (Mw/Mn) in the range of from about 1.0 to about 2.0, or (iii) the liquid diene rubber has a glass transition temperature ranging from about −100° C. to about 30° C., or (iv) a combination of (i), (ii) and (iii)
and
the weight ratio of the peroxide crosslinking agent to the liquid diene rubber is from about 0.01 to about 1.

20. The process of claim 16, wherein the moldable thermoplastic elastomer composition comprises:
(a) 100 parts by weight of an addition block copolymer thermoplastic elastomer having at least one polymer block (A) comprising units derived from an aromatic vinyl compound, and at least one polymer block (B) comprising units derived from a conjugated diene compound, wherein the block copolymer is crosslinked in both the blocks (A) and (B);
(b) a polyolefin component in an amount of from about 10 to about 300 parts by weight;
(c) a rubber softener component in an amount of from about 10 to about 300 parts by weight; and
(d) a liquid diene rubber in an amount of from about 1 to about 50 parts by weight,
wherein at least a portion of the liquid diene rubber is chemically bonded to the addition block copolymer, and
the composition is thermoplastic, elastic and moldable.
